(19) United States
(12) Patent Application Publication
(10) Pub. No.: US 2009/0190544 A1
(43) Pub. Date: Jul. 30, 2009

(54) METHOD AND APPARATUS FOR CHANNEL IDENTIFICATION IN A WIRELESS COMMUNICATION SYSTEM

(75) Inventors: Arnaud Meylan, Bois-Colombes (FR); Masato Kitazoe, Tokyo (JP); Nathan Edward Tenny, Poway, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/356,443

(22) Filed: Jan. 20, 2009

Related U.S. Application Data
(60) Provisional application No. 61/023,815, filed on Jan. 25, 2008.

(51) Int. Cl. H04W 74/00

(52) U.S. Cl. 370/329

(57) ABSTRACT

Systems and methodologies are described that facilitate classification and identification of a channel associated with a wireless data transmission. As described herein, a channel designated for transmission of a packet can be selected from among multiple usable channels, based on which a bit at a predefined location in the packet can be set to a logical value indicative of the selected channel. As further described herein, extraction of the logical value from the predefined location and identification of the corresponding channel can be performed by a recipient of the packet without requiring parsing of the message. In one example described herein, a Dedicated Control Channel (DCCH) can be identified by setting a Logical Channel Identifier (LCID) bit in a DCCH packet to a predefined value. In another example, a Common Control Channel (CCCH) can be identified by embedding a Boolean constant within a message structure contained in a CCCH packet.

### CROSS-REFERENCE

This application claims the benefit of U.S. Provisional Application Ser. No. 61/023,815, filed Jan. 25, 2008, and entitled “METHOD AND APPARATUS FOR DIFFERENTIATING A CCCH MESSAGE FROM A DCCH MESSAGE,” the entirety of which is incorporated herein by reference.

### BACKGROUND

I. Field

The present disclosure relates generally to wireless communications, and more specifically to techniques for classification of signals transmitted over a wireless communication system.

II. Background

Wireless communication systems are widely deployed to provide various communication services; for instance, voice, video, packet data, broadcast, and messaging services can be provided via such wireless communication systems. These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems, and Orthogonal Frequency Division Multiple Access (OFDMA) systems.

Generally, a wireless multiple-access communication system can simultaneously support communication for multiple wireless terminals. In such a system, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out (SISO), multiple-in-signal-out (MISO), or a multiple-in-multiple-out (MIMO) system.

Various procedures conducted within a wireless communication system can be made flexible in their implementation such that, for example, one or more participating wireless devices can utilize one or more of a variety of options (e.g., signal types, communication channels, etc.) in carrying out the procedures. For example, during a connection establishment procedure between a terminal and a base station, the terminal can communicate one or more messages to the base station over a Common Control Channel (CCCH) or a Dedicated Control Channel (DCCH). In such a procedure, a base station and/or another device for which messages are designated can utilize different process flows depending on the channel over which the messages are received. However, if the destination device does not know a priori which channel is being utilized for communication of the messages, the destination device can experience difficulty in identifying the correct channel and/or in selecting and executing the appropriate corresponding process flow. Accordingly, it would be desirable to implement improved techniques for signal classification and/or differentiation in a wireless communication system.

### SUMMARY

The following presents a simplified summary of various aspects of the claimed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed aspects in a simplified form as a prelude to the more detailed description that is presented later.

According to an aspect, a method for indicating a channel associated with a transmission in a wireless communication system is described herein. The method can comprise identifying a channel on which a data packet is to be transmitted from a first channel or a second channel; formatting the data packet using a protocol associated with a first layer according to a format associated with the identified channel; and setting a bit in the data packet at a position known by a second layer at an intended recipient of the data packet to a first logical value if the first channel has been identified or to a second logical value if the second channel has been identified.

Another aspect relates to a wireless communications apparatus, which can comprise a memory that stores data relating to a Radio Resource Control (RRC) layer protocol, a first channel, a second channel, and a receiving device. The wireless communications apparatus can further comprise a processor configured to select a channel for transmitting a Protocol Data Unit (PDU) to the receiving device from the first channel and the second channel, to format the PDU using the RRC layer protocol based on a PDU structure associated with the selected channel, and to set a bit in the PDU at a predefined position known by a Medium Access Control (MAC) entity at the receiving device to a first logical value if the first channel is selected or a second logical value if the second channel is selected.

A third aspect relates to an apparatus that facilitates channel differentiation in a wireless communication system. The apparatus can comprise means for determining a channel on which a packet is to be transmitted; and means for setting an n-th most significant bit of the packet to a value indicative of the determined channel, where n is known by an intended recipient of the packet.

A fourth aspect relates to a computer program product, which can include a computer-readable medium that comprises code for determining whether a MAC PDU is to be transmitted using a first channel or a second channel; and code for setting a logical value at a predefined bit position within the MAC PDU that is known a priori to an intended receiver of the MAC PDU to a first logical value if the MAC PDU is to be transmitted using the first channel or to a second logical value if the MAC PDU is to be transmitted using the second channel.

A fifth aspect relates to an integrated circuit that executes computer-executable instructions for providing channel identification information within a data transmission. The instructions can comprise selecting a logical channel associated with a data transmission from the group consisting of a first logical channel and a second logical channel; identifying a bit position within the data transmission that is known to an intended recipient of the data transmission; and setting the identified bit position to a first value selected from the group consisting of 0 and 1 if the first logical channel has been selected or to a second value selected from the group consisting of 0 and 1 that is different from the first value if the second logical channel has been selected.

According to another aspect, a method for identifying a channel associated with a packet transmission is provided herein. The method can comprise receiving a packet constructed by a first layer associated with a transmitting device that includes a channel identification bit at a predetermined bit location; analyzing the predetermined bit location in the packet using a second layer to obtain the channel identification bit; and determining a channel associated with the packet based on a logical value of the channel identification bit.

An additional aspect relates to a wireless communications apparatus that can comprise a memory that stores data relating to a transmitting station, a first channel, a second channel, and an integer n. The wireless communications apparatus can further comprise a processor configured to receive a PDU from the transmitting station, extract a value of an n-th most significant bit within the PDU, and to associate the first channel with the PDU if the extracted value is a first logical value or to associate the second channel with the PDU if the extracted value is a second logical value.

A further aspect relates to an apparatus that facilitates identification of a channel associated with a transmitted packet. The apparatus can comprise means for receiving a packet from a network device; means for obtaining a value of a bit located at a predetermined location in the packet; and means for determining a channel on which the packet was transmitted based on the obtained bit value.

Another aspect described herein relates to a computer program product, which can include a computer-readable medium that comprises code for receiving a MAC PDU; code for extracting a logical value associated with a predefined bit position within the MAC PDU; and code for parsing the MAC PDU according to a first channel format if the extracted logical value is 0 or according to a second channel format if the extracted logical value is 1.

Still another aspect relates to an integrated circuit that executes computer-executable instructions for identifying a channel over which a data transmission is provided. The instructions can comprise identifying a bit position within a data transmission that is known to a device from which the data transmission is provided; obtaining a value selected from the group consisting of 0 and 1 from the identified bit position of the data transmission; and determining that a first channel was used for the data transmission if the obtained value is 0 or that a second channel was used for the data transmission if the obtained value is 1.

To the accomplishment of the foregoing and related ends, one or more aspects of the claimed subject matter comprise the features hereinafter fully described and particularly pointed out in the claims. The following description and the annexed drawings set forth in detail certain illustrative aspects of the claimed subject matter. These aspects are indicative, however, of but a few of the various ways in which the principles of the claimed subject matter can be employed. Further, the disclosed aspects are intended to include all such aspects and their equivalents.

### BRIEF DESCRIPTION OF THE DRAWINGS

FIG. 1 is a block diagram of a system for channel differentiation and identification in a wireless communication system in accordance with various aspects.

FIG. 2 is a block diagram of a system for embedding and extracting channel information associated with a data transmission in accordance with various aspects.

FIG. 3 illustrates an example connection establishment procedure that can be implemented in a wireless communication system in accordance with various aspects.

FIGS. 4-6 illustrate various example packet structures that can be utilized in accordance with various aspects described herein.

FIG. 7 is a flow diagram of a methodology for transmitting a data packet to a receiver that indicates a channel over which the data packet is transmitted.

FIG. 8 is a flow diagram of a methodology for incorporating a channel identifier into a transmission for a wireless receiver.

FIG. 9 is a flow diagram of a methodology for analyzing a message transmitted over a wireless communication system to discover a channel over which the message was transmitted.

FIGS. 10-11 are block diagrams of respective apparatus that facilitate channel identification for data transmitted over a wireless communication system.

FIG. 12 illustrates a wireless multiple-access communication system in accordance with various aspects set forth herein.

FIG. 13 is a block diagram illustrating an example wireless communication system in which various aspects described herein can function.

### DETAILED DESCRIPTION

Various aspects of the claimed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, an integrated circuit, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various aspects are described herein in connection with a wireless terminal and/or a base station. A wireless terminal can refer to a device providing voice and/or data connectivity to a user. A wireless terminal can be connected to a computing device such as a laptop computer or desktop computer, or it can be a self contained device such as a personal digital assistant (PDA). A wireless terminal can also be called a system, a subscriber unit, a subscriber station, mobile station, mobile, remote station, access point, remote terminal, access terminal, user terminal, user agent, user device, or user equipment (UE). A wireless terminal can be a subscriber station, wireless device, cellular telephone, PCS telephone, cordless telephone, a Session Initiation Protocol (SIP) phone, a wireless local loop (WLL) station, a personal digital assistant (PDA), a handheld device having wireless connection capability, or other processing device connected to a wireless modem. A base station (e.g., access point or Node B) can refer to a device in an access network that communicates over the air-interface, through one or more sectors, with wireless terminals. The base station can act as a router between the wireless terminal and the rest of the access network, which can include an Internet Protocol (IP) network, by converting received air-interface frames to IP packets. The base station also coordinates management of attributes for the air interface.

Moreover, various functions described herein can be implemented in hardware, software, firmware, or any combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media can be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc (BD), where disks usually reproduce data magnetically and discs reproduce data optically with lasers. Combinations of the above should also be included within the scope of computer-readable media.

Various techniques described herein can be used for various wireless communication systems, such as Code Division Multiple Access (CDMA) systems, Time Division Multiple Access (TDMA) systems, Frequency Division Multiple Access (FDMA) systems, Orthogonal Frequency Division Multiple Access (OFDMA) systems, Single Carrier FDMA (SC-FDMA) systems, and other such systems. The terms “system” and “network” are often used herein interchangeably. A CDMA system can implement a radio technology such as Universal Terrestrial Radio Access (UTRA), CDMA2000, etc. UTRA includes Wideband-CDMA (W-CDMA) and other variants of CDMA. Additionally, CDMA2000 covers the IS-2000, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Further, CDMA2000 and UMB are described in documents from an organization named “3rd Generation Partnership Project 2” (3GPP2).

Various aspects will be presented in terms of systems that can include a number of devices, components, modules, and the like. It is to be understood and appreciated that the various systems can include additional devices, components, modules, etc. and/or can not include all of the devices, components, modules etc. discussed in connection with the figures. A combination of these approaches can also be used.

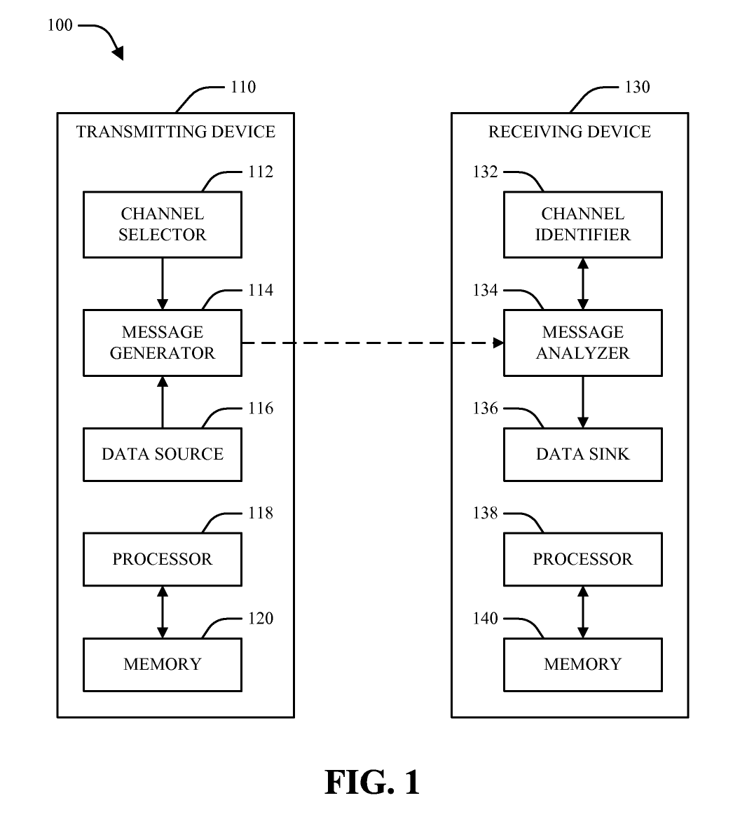

Referring now to the drawings, FIG. 1 illustrates a block diagram of a system 100 for channel differentiation and identification in a wireless communication system in accordance with various aspects provided herein. In one example, system 100 can include one or more devices 110 and/or 130, which can communicate with each other and/or with other devices in system 100 using any suitable communications methodology. While FIG. 1 illustrates two devices 110 and 130, it should be appreciated that system 100 can include any suitable number of devices. In another example, a first device 110 can conduct transmission of one or more messages to a second device 130. However, while device 110 is designated as a “transmitting” device and device 130 is designated as a “receiving” device, it should be appreciated that communication could additionally and/or alternatively be conducted from device 130 to device 110. In addition, it can be appreciated that device 110 and/or 130 can be and/or implement the functionality of, for example, terminals, base stations, and/or any other suitable type of device. As used herein and generally in the art, a terminal can be referred to as a mobile terminal, a user equipment (UE), an access terminal (AT), or the like. Further, a base station can be referred to as an access point (AP), a Node B, or the like. As additionally used herein, a communication from a base station to a terminal is referred to as a downlink (DL) or forward link communication, while a communication from a terminal to a base station is referred to as an uplink (UL) or reverse link communication.

In accordance with one aspect, transmitting device 110 can communicate data to receiving device 130 over one or more channels in frequency, code, space, or the like. In one example, a channel utilized by transmitting device 110 can be selected from a set of multiple usable channels based on various factors. Accordingly, a channel selector 112 and/or other suitable means can be employed by transmitting device 110 to select a channel to utilize for transmission of a message to receiving device 130. Based on the channel selected by channel selector 112 and/or data obtained from a data source 116, a message generator 114 can be utilized to format and generate the message, which can subsequently be provided to receiving device 130. At receiving device 130, the message can be processed by a message analyzer 134, which can work in combination with a channel identifier 132 and/or any other suitable means to identify a channel associated with the message. Additionally and/or alternatively, data contained in the message can be provided to a data sink 136.

In an example where transmitting device 110 can provide a message to receiving device 130 using one of a plurality of possible channels, formatting applied to the message by message generator 114 can vary depending on the channel chosen by channel selector 112 to be utilized for the message. Accordingly, message analyzer 134 at receiving device 130 can utilize channel identifier 132 to determine which channel was selected for use by transmitting device 110 in order to parse the message in an appropriate manner. However, if the channel utilized by transmitting device 110 to provide the message to receiving device 130 is not made known or otherwise readily available to receiving device 130, channel identifier 132 at receiving device 130 can experience difficulty in identifying the correct channel, which can lead to inefficient parsing of the message. For example, receiving device 130 may be forced to parse the message multiple times, based on which channel identifier 132 can be utilized to determine a correctly parsed version of the message in order to identify the appropriate channel. Alternatively, receiving device may be forced to parse a portion of the message, such as a packet header or the like, in order to identify the appropriate channel before performing additional processing. However, partial parsing in this manner can require receiving device 130 to pass a received message between layers multiple times, which can degrade the performance of receiving device 130.

Accordingly, to mitigate the above shortcomings and/or other shortcomings of existing wireless communication systems, transmitting device 110 can provide an indication of a channel utilized to convey a message to receiving device 130 within the message itself. This can be accomplished by, for example, setting a bit at a predetermined location within the message to a logical value corresponding to the channel utilized to transmit the message. In one example, the predetermined location within the message can be known a priori to both transmitting device 110 and receiving device 130. For example, the location can be programmed into a respective memory 120 and/or 140 associated with devices 110 and/or 130 upon initial setup of the respective devices. Alternatively, a device 110 and/or 130 can inform one or more other devices 110 and/or 130 of the location in one or more preceding messages. As another alternative, any other suitable technique for providing the location to devices 110 and/or 130 could be utilized.

In accordance with one aspect, by setting a bit at a predetermined location within a message transmitted from transmitting device 110 to receiving device 130, channel identifier 132 at receiving device 130 can identify the appropriate channel by determining the logical value of the message at the predetermined bit location. In one example, channel identifier 132 can be utilized to examine the predetermined bit location at the message even if channel identifier 132 is itself unable to parse the message, thereby allowing the channel associated with the message to be identified and the message to be appropriately parsed in a single pass. For example, a first layer at transmitting device 110 can set a bit at a given location within a message to a known value, and a second, lower layer at receiving device 130 can analyze the message to obtain the value present at the given location. In this manner, it can be appreciated that various techniques illustrated by system 100 can essentially function as a layering function by design, wherein a given layer at receiving device 130 can obtain information from data encoded by transmitting device 110 using a higher-layer protocol that the given layer at receiving device 130 lacks sufficient knowledge to properly parse.

By way of specific example, a message transmitted from transmitting device 110 to receiving device 130 can be a connection establishment message, which can be transmitted over either a Common Control Channel (CCCH) or a Dedicated Control Channel (DCCH). After channel selector 112 selects an appropriate channel, message generator 114 can format the message for the selected channel. In addition, message generator 114 can set a predetermined bit in the message to a corresponding logical value to indicate the channel used (e.g., 0 for CCCH and 1 for DCCH or vice versa). In addition to the predetermined bit location, a mapping between CCCH and DCCH and their corresponding logical values can also be known a priori by receiving device 130 such that channel identifier 132 at receiving device 130 can determine the correct channel by examining the logical value of the appropriate bit in the message.

While the above example describes a scenario involving one predetermined bit location and two possible channels, it could be appreciated that the techniques described herein could be expanded for any suitable number of bits and/or channels. For example, a similar technique to the above could be utilized to distinguish between up to 2ⁿ potential channels by setting values of n predetermined adjacent and/or non-adjacent bit locations in a message between transmitting device 110 and receiving device 130 for any integer value of n.

In accordance with another aspect, transmitting device 110 can utilize a processor 118 and/or memory 120 to implement at least a portion of the functionality of channel selector 112, message generator 114, data source 116, and/or any other component(s) described herein. Further, receiving device 130 can include a processor 138 and/or memory 140 to implement some or all of the functionality of channel identifier 132, message analyzer 134, data sink 136, and/or any other component(s) of receiving device 130. In one example, processor 118 at transmitting device 110 and/or processor 138 at receiving device 140 can further utilize one or more artificial intelligence (AI) techniques to automate some or all of their respective functionalities. As used herein, the term “intelligence” refers to the ability to reason or draw conclusions about, e.g., infer, the current or future state of a system based on existing information about the system. Artificial intelligence can be employed to identify a specific context or action, or generate a probability distribution of specific states of a system without human intervention. Artificial intelligence relies on applying advanced mathematical algorithms—e.g., decision trees, neural networks, regression analysis, cluster analysis, genetic algorithm, and reinforced learning—to a set of available data (information) on the system. In particular, one of numerous methodologies can be employed for learning from data and then drawing inferences from the models so constructed, e.g., hidden Markov models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches (that perform data fusion, etc.) in accordance with implementing various automated aspects described hereinafter.

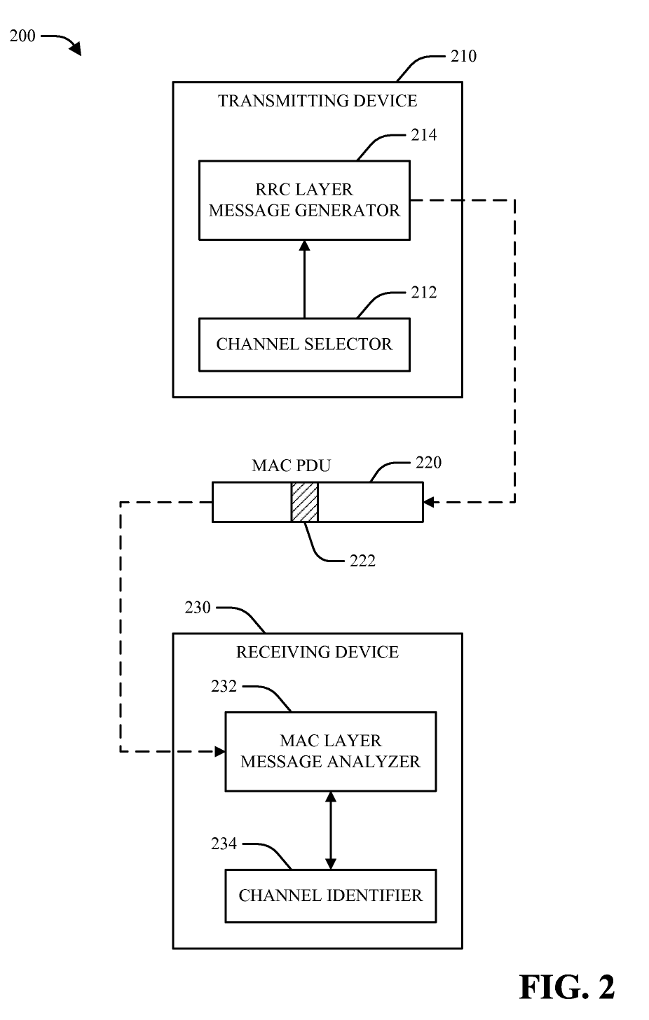

Turning now to FIG. 2, a system 200 for embedding and extracting channel information associated with a data transmission in accordance with various aspects is illustrated. As FIG. 2 illustrates, system 200 can include a transmitting device 210, which in one example can transmit a message encapsulated into one or more Medium Access Control (MAC) Protocol Data Units (PDUs) 220 to a receiving device 230. The communication illustrated by system 200 can be an uplink communication, wherein transmitting device 210 is a UE and receiving device 230 is a Node B, or alternatively the communication can be a downlink communication from a Node B to a UE. By way of further non-limiting example, the transmission illustrated by system 200 can be conducted as part of a connection establishment procedure between devices 210 and 230. Various examples of connection establishment procedures that can be utilized are described in further detail infra.

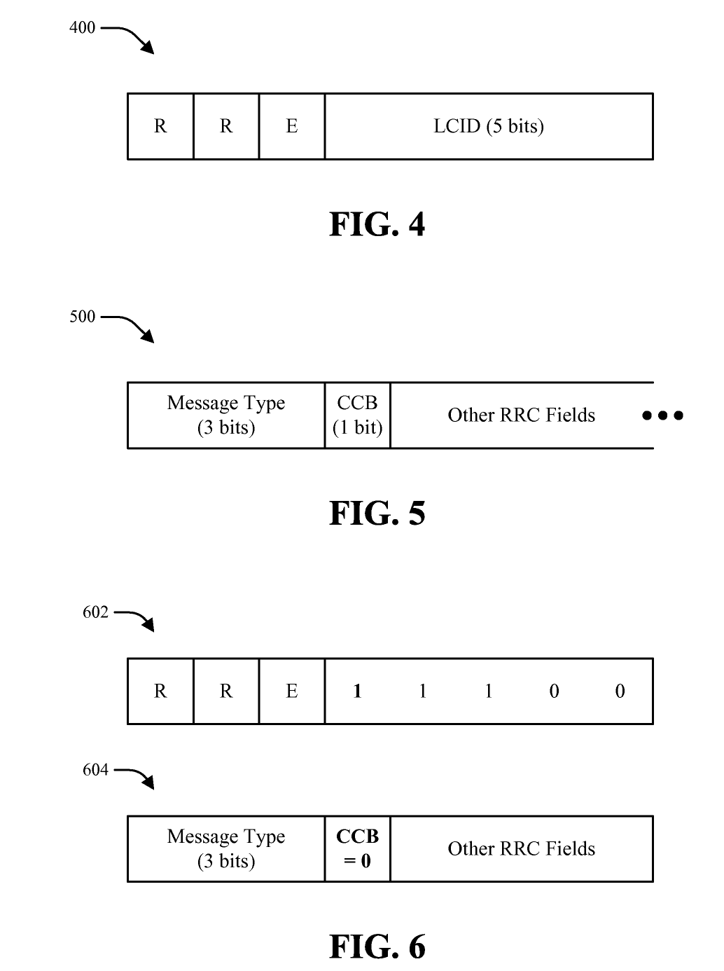

In accordance with one aspect, transmitting device 210 can utilize one of a multiple of logical channels (e.g., CCCH, DCCH, etc.) to communicate PDU 220. In one example, a channel selector 212 can be used by transmitting device 210 to select an appropriate channel. Based on the selected channel, a Radio Resource Control (RRC) layer message generator 214 can be utilized to format a message to be transmitted within the PDU 220 according to the selected channel format. In another example, generation of a RRC message to be encapsulated within PDU 220 can be performed as a function of a channel to be utilized in transmitting PDU 220 and/or a message format associated with the channel (e.g., DCCH PDU format 400 in FIG. 4 and/or CCCH PDU format 500 in FIG. 5, both of which are described in further detail infra).

Upon generation and formatting of the message by RRC layer message generator 214, PDU 220 can be transmitted to receiving device 230. Upon receiving PDU 220, a MAC layer message analyzer 232 at receiving device 230 can perform initial processing for PDU 220. However, in certain cases, PDU 220 may be received at receiving device 230 in such a way that the logical channel over which PDU 220 was communicated is not known to receiving device 230. Stated another way, one or more entities associated with the MAC protocol layer at receiving device 230, such as MAC layer message analyzer 232, can operate to transparently pass higher layer RRC messages provided in respective PDUs 220. However, in such a case, it can be appreciated that the MAC behavior of receiving device 230 can be dependent on the logical channel on which a given PDU 220 arrives. Thus, in contexts where the MAC layer of receiving device 230 operates transparently and PDU 220 can arrive on multiple channels (e.g., CCCH or DCCH), there is traditionally no ready way for the MAC layer to distinguish between the logical channels based on the information available to the MAC layer. This difficulty, in turn, can impede the functionality of receiving device 230. For example, MAC layer message analyzer 232 and/or other components of receiving device 230 can execute different process flows in certain cases based on the channel on which PDU 220 is received. More particularly, MAC layer message analyzer 232 and/or other components of receiving device 230 can process PDU 220 differently, PDU 220 can be routed to different software components, and/or other aspects of the processing of PDU 220 can be altered depending on the logical channel associated with PDU 220.

Thus, to facilitate knowledge of the channel over which PDU 220 is communicated, transmitting device 210 can set one or more flags, or common control bits (CCBs) 222, within PDU 220 at a predetermined location within PDU 220. The CCBs 222 can subsequently be utilized by MAC layer message analyzer 232, a channel identifier 234, and/or any other suitable component of receiving device 230 to ascertain the channel associated with PDU 220 and, consequentially, the format of PDU 220.

In accordance with one aspect, a RRC layer protocol can be utilized by transmitting device 210, e.g., via RRC layer message generator 214 and/or another suitable component, to set a CCB 222 in the proper position within PDU 220. In one example, the position of CCB 222 within PDU 220 can be predetermined and known a priori to transmitting device 210 and receiving device 230 such that MAC layer message analyzer 232 at receiving device 230 can read CCB 222 within PDU 220 even if it does not have knowledge of the RRC message format utilized by transmitting device 210. Thus, in one example, MAC layer message analyzer 232 and/or channel identifier 234 at receiving device 230 can identify a channel associated with PDU 220 by examining PDU 220, locating the position of CCB(s) 222 within PDU 220, and determining the logical value(s) of CCB(s) 222. The position of a CCB 222 within PDU 220 can be fixed to an n-th most significant bit in PDU 220 (e.g., a fourth most significant bit and/or any other appropriate bit position), or it can be appreciated that the position of a CCB 222 within respective PDUs 220 can be configured to change dynamically over time. Further, it can be appreciated that multiple CCBs 222 can be provided within a PDU 220 to, for example, facilitate identification of a channel from a set of more than two possible channels.

In accordance with another aspect, a mapping relationship between logical channels that can be utilized by transmitting device 210 and respective values of CCB(s) 222 within PDU 220 can additionally be known a priori to transmitting device 210 and receiving device 230. Thus, transmitting device can indicate a first channel (e.g., DCCH) by setting CCB 222 to a first logical value (e.g., 1) and/or a second channel (e.g., CCCH) by setting CCB 222 to a second logical value (e.g., 0). In a similar manner to the positioning of CCB 222 within PDU 220, a mapping between respective channels and corresponding values of CCB(s) 222 can be fixed and/or dynamically configurable.

In accordance with a further aspect, a process of analyzing CCB(s) 222 in order to determine a channel associated with PDU 220 can be implemented at receiving device 230 as a designed layering violation. More particularly, a MAC layer protocol at receiving device 230 can be enabled to analyze a RRC-coded bit-stream provided by PDU 220 and extract information from a portion of the bit-stream despite the fact that the MAC layer protocol may lack sufficient knowledge of the RRC message format to properly parse the bit-stream. Thus, in one example, MAC layer message analyzer 232 can be provided with sufficient structural information regarding PDU 220 in order to obtain information from CCB(s) 222 even if it lacks knowledge of the RRC layer to parse PDU, thereby bypassing the normal parsing procedure associated with system 200 and utilizing data provided by a different layer.

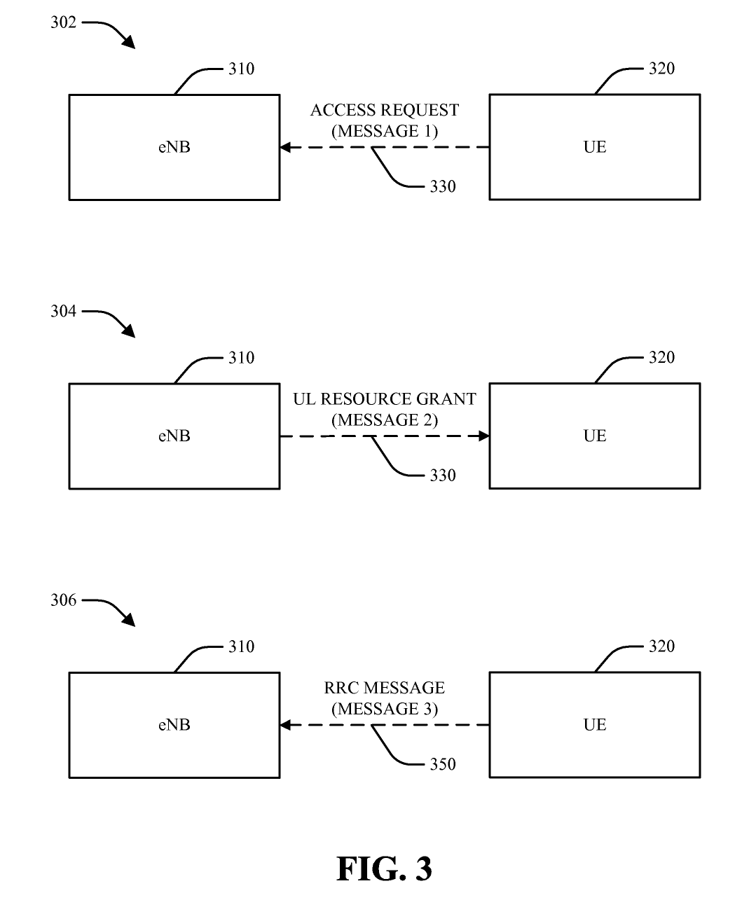

Referring next to FIG. 3, a series of diagrams 302-306 are provided that illustrate an example connection establishment procedure that can be implemented in a wireless communication system in accordance with various aspects. It should be appreciated, however, that the procedure illustrated by FIG. 3 and described as follows is provided merely as a non-limiting example of a procedure that can utilize the channel differentiation techniques described herein and that, unless explicitly stated otherwise, any suitable procedure involving the transmission of data between devices in a wireless communication system is intended to fall within the scope of the techniques described herein and the hereto appended claims.

In one example, the procedure illustrated by diagrams 302-306 can be utilized in a wireless communication system, such as a 3GPP LTE communication system, that includes one or more Evolved Node Bs (eNBs) 310 and one or more UEs 320. In another example, a Random Access Channel (RACH) and/or another suitable uplink transport channel can be used to transfer control information from UE 320 to eNB 310 for, e.g., initial access for connection setup, location area updates, or the like. Additionally and/or alternatively, RACH can be used for transport of small and infrequent user data packets. In accordance with one aspect, RACH can function as a contention-based channel, wherein collisions can occur due to several UEs 320 simultaneously accessing RACH, as a result of which an initial access message cannot be decoded by eNB 310.

In accordance with one aspect, UE 320 can initialize the process illustrated by FIG. 3 as shown by diagram 302, wherein UE 320 sends a first physical message 330 (e.g., Message 1) to eNB 310 using a Physical RACH (PRACH). In one example, Message 1 330 can be an initial access request message that can contain a signature sequence. Next, as illustrated by diagram 304, eNB 310 can respond with its own message 340 (e.g., Message 2). In one example, message 2 340 can echo a signature sequence provided by UE 320 in Message 1 330. Further, Message 2 340 can contain an uplink grant, transport format and/or timing advance that can enable UE 320 to transmit a Message 3 350 as illustrated by diagram 306. In one example, Message 3 350 can contain a connection request message that includes a reason for the request. Message 3 350 can, in accordance with one aspect, be transported on an Uplink Shared Channel (UL-SCH) transport channel.

In accordance with another aspect, to perform initial access over an air (e.g., wireless) interface, the procedure illustrated by diagrams 302-306 can be implemented as a physical random access procedure. In one example, the procedure can utilize the RACH and two physical channels, e.g., PRACH and an Acquisition Indication Channel (AICH). The RACH can be mapped to the uplink physical channel (e.g., PRACH), while the AICH can be implemented as a downlink common channel that exists as a pair with the PRACH used for random access control.

In one example, a Message 2 340 received by UE 320 can indicate an UL resource grant for a subsequent Message 3 350. Accordingly, UE 320 can transmit a first scheduled message (e.g., Message 3 350), which can contain a RRC message to eNB 310. Thus, it can be appreciated that Message 3 350, as illustrated by diagram 306, can be the first communication from UE 320 to eNB 310 that uses scheduled resources assigned to UE 320 (e.g., via Message 2 340 from eNB 310). In one example, depending on the implemented use case, an RRC message associated with Message 3 350 can be carried by, for example, CCCH or DCCH. However, at the stage of the process illustrated by diagram 306, eNB 310 may not have enough information from UE 320 to determine which use case has been implemented and, consequentially, which channel has been utilized for the transmission of Message 3 350.

Accordingly, eNB 310 and/or UE 320 can implement various techniques as described herein to differentiate CCCH from DCCH on Message 3 350. By way of specific example, a DCCH message can be configured to use a regular MAC sub-header with a length of one octet or more, such that the MAC header for DCCH occupies the first octet within a MAC PDU (e.g., packet) corresponding to Message 3 350. Conversely, CCCH can be configured to use no MAC header, such that the first octet within a MAC PDU can instead be occupied by the RRC message. Various techniques for constructing a MAC PDU for CCCH and/or DCCH transmission are described in further detail infra.

Turning now to FIG. 4, a first example packet structure 400 that can be utilized in accordance with various aspects provided herein is presented. In one example, packet structure 400 illustrates a MAC PDU format that can be applied to messages transmitted using DCCH. However, it should be appreciated that any suitable packet structure, including those illustrated by FIGS. 4-6 or otherwise, could be utilized with the techniques described herein. In accordance with one aspect, packet structure 400 can be an 8-bit structure, which can include one or more header bits followed by a Logical Channel Identifier (LCID). While structure 400 illustrates a 5-bit LCID, it should be appreciated that the LCID can be any suitable length. Further, while the LCID is positioned at the least significant bits of structure 400, LCID could alternatively be positioned in any suitable manner.

In one example, header bits in structure 400 can include one or more reserved bits (denoted as R) and/or one or more extension bits (denoted as E). Extension bits can denote, for example, that a MAC sub-header follows structure 400. Additionally and/or alternatively, one or more reserved bits can be utilized as request or “happy” bits, which can be used to denote that a transmitting entity requires further resources. In another example, the LCID can be set to 11100 and/or any other appropriate value.

FIG. 5 illustrates a second example packet structure 500 that can be utilized in accordance with various aspects provided herein. In one example, packet structure 500 illustrates a MAC PDU format that can be applied to messages transmitted using CCCH. However, it should be appreciated that any suitable packet structure, including those illustrated by FIGS. 4-6 or otherwise, could be utilized with the techniques described herein. In accordance with one aspect, most significant bits of packet structure 500 can be allocated to a Message Type field. As further illustrated, less significant bits in packet structure 500 can then be allocated to a CCB and/or other RRC fields. While packet structure 500 illustrates a 3-bit Message Type field, it can be appreciated that Message Type field can utilize any suitable size and/or positioning. For example, the size of the Message Type field can be selected to coincide with the number of reserved and/or extension bits provided in DCCH packet structure 400 such that the CCB provided in CCCH packet structure 500 is always set to the opposite value of the corresponding bit in the LCID provided in the DCCH packet structure 400. In doing so, it can be appreciated that DCCH can be differentiated from CCCH by examining the position associated with the CCB in structure 500 (e.g., the fourth bit position).

Accordingly, in the example illustrated by FIG. 6, a DCCH packet structure 602 can be distinguished from a CCCH packet structure 604 by examining the logical value of the bit located at the position corresponding to the CCB in CCCH packet structure 604. As the example DCCH packet structure 602 illustrates a LCID value of 11100, the CCB in CCCH packet structure 604 can be set to 0, which is the opposite value of the most significant bit in the LCID provided by DCCH packet structure 602. Thus, it can be appreciated that the most significant bit of the LCID field provided by DCCH structure 602 and/or the designated CCB in CCCH structure 604 can serve as a CCB to aid an entity receiving an associated packet in determining a channel associated with the packet. It should be further appreciated that while a CCB value of 1 is associated with DCCH and a CCB value of 0 is associated with CCCH in FIG. 6, DCCH and CCCH could alternatively be designated by logical values of 0 and 1, respectively. Additionally, it should be appreciated that the concepts illustrated and described herein can apply to distinguish between any suitable logical channels based on any suitable mapping between respective channels and corresponding logical values.

Returning to FIG. 5, the Message Type field in CCCH packet structure 500 can in one example be assigned 3 bits in order to ensure that the CCB occupies the fourth bit and does not collide with the E/R/R bits in DCCH structure 400. In one example, the Message Type field can indicate a type of RRC message that is carried by CCCH corresponding to the packet illustrated by structure 500. For example, the Message Type field can indicate a RRC CONNECTION REQUEST message, a RRC CONNECTION RE-ESTABLISHMENT REQUEST message, and/or any other suitable type of message.

In accordance with one aspect, a CCB can be encoded within CCCH structure 500 as a 1-bit field and set to a fixed value which is opposite from the value appearing in the corresponding position of the reserved LCID in DCCH structure 400. In accordance with another aspect, the Abstract Syntax Notation #1 (ASN.1) message structure can be leveraged to ensure that the CCB in CCCH structure 500 is the first field of any message defined in the choice of the Message Type as follows. As generally known in the art, ASN.1 can be utilized as an encoding format for messages in order to guarantee that said messages can be transported as an encoded bit stream and understood by a receiving entity without requiring knowledge of lower-layer characteristics of the transport medium and/or similar information.

In one example, an ASN.1 message can be structured as a set of fields, such that respective fields are encoded in the order in which they appear. Accordingly, fields comprising CCCH structure 500 can be arranged in a nested fashion such that the CCB is encoded in the first bit position after the Message Type field. For example, CCCH structure 500 can be constructed using the ASN.1 message format illustrated below in Table 1.

TABLE 1
ASN.1 message structure for CCCH structure 500.

UL-CCCH-Message ::= SEQUENCE {

| | |
|---|---|
| messageType | CHOICE { |

| | |
|---|---|
| rrcMessageA | RRCMessageA, |
| rrcMessageB | RRCMessageB, |
| spare6 | NULL, |
| spare5 | NULL, |
| spare4 | NULL, |
| spare3 | NULL, |
| spare2 | NULL, |
| spare1 | NULL |

}

}
RRCMessageA ::= SEQUENCE {

| | | |
|---|---|---|
| CCB | Boolean, | -- Always set to FALSE |

| | |
|---|---|
| otherRRC-Fields | SEQUENCE { |

...

}

}
RRCMessageB ::= SEQUENCE {

| | | |
|---|---|---|
| CCB | Boolean, | -- Always set to FALSE |

| | |
|---|---|
| otherRRC-Fields | SEQUENCE { |

...

}

}

By utilizing the ASN.1 message structure shown in Table 1, it can be appreciated that an ASN.1 encoder can produce a bit-stream whose fourth output bit contains the value of the reserved bit CCB as shown in structure 500. First, it can be observed that the Message Type field is defined in Table 1 as a choice from among a eight possible message types, thereby causing the message type selection to take on a 3-bit value. In one example, the Message Type field can specify one or more known message types rrcMessageA and/or rrcMessageB, which can correspond to, e.g., a RRC CONNECTION REQUEST message and/or a RRC CONNECTION RE-ESTABLISHMENT REQUEST message, respectively. Further, as Table 1 illustrates, the Message Type field can additionally contain one or more spare or null selections in order to pad the size of the Message Type field to the required size (e.g., 3 bits).

Additionally, it can be appreciated from the ASN.1 message structure in Table 1 that at any given depth of nesting, the fields that appear will be encoded in order as long as there are no special metadata, such as presence bits for optional fields, that are required to be encoded at the front of the message. Thus, if optional fields are present in a message, the first items encoded into the layer of nesting associated with the optional fields will be a list of bits that specify the presence and/or absence of the optional fields. However, it can be appreciated that in a case such as this, the contents of the first field will not be encoded as the first bits in the transported bit-stream. Accordingly, Table 1 illustrates that respective message formats (e.g., rrcMessageA, rrcMessageB, etc.) can be formatted in a sequence structure to put a discriminator bit (e.g., CCB) that is set to a fixed Boolean value (e.g., false or 0) as the first bit of the message. Additionally, to prevent metadata fields from being encoded prior to the CCB, Table 1 further illustrates that the remainder of the respective message formats can be encapsulated into a sequence structure at a deeper layer of nesting such that any metadata associated with the remainder of the message will be associated with the nested container and will not appear in the bit-stream before the CCB.

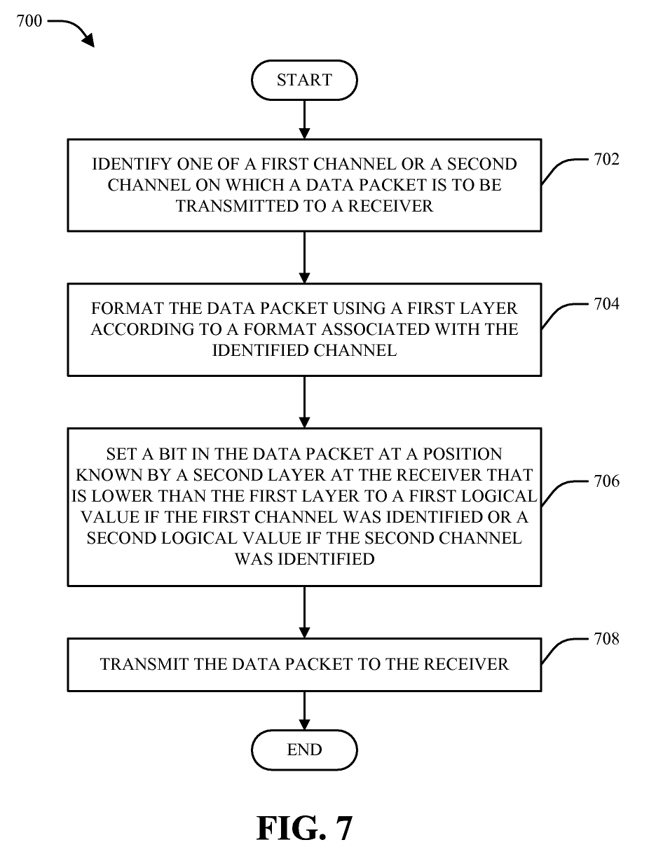

Referring to FIGS. 7-9, methodologies that can be performed in accordance with various aspects set forth herein are illustrated. While, for purposes of simplicity of explanation, the methodologies are shown and described as a series of acts, it is to be understood and appreciated that the methodologies are not limited by the order of acts, as some acts can, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

With reference to FIG. 7, illustrated is a methodology 700 for transmitting a data packet to a receiver (e.g., a receiving device 130 in system 100) that indicates a channel over which the data packet is transmitted. It is to be appreciated that methodology 700 can be performed by, for example, a base station, a wireless terminal, and/or any other appropriate network device (e.g., a network device acting as a transmitting device 110). Methodology 700 begins at block 702, wherein one of a first channel (e.g., CCCH) or a second channel (e.g., DCCH) on which a data packet is to be transmitted to a receiver is identified. At block 704, the data packet is formatted using a first layer (e.g., RRC) according to a format associated with the channel identified at block 702. Next, at block 706, a bit in the data packet at a position known by a second layer at the receiver (e.g., MAC) that is lower than the first layer utilized at block 704 is set to a first logical value (e.g., 0) if the first channel was identified at block 702 or a second logical value (e.g., 1) if the second channel was identified at block 702. Finally, at block 708, the data packet is transmitted to the receiver.

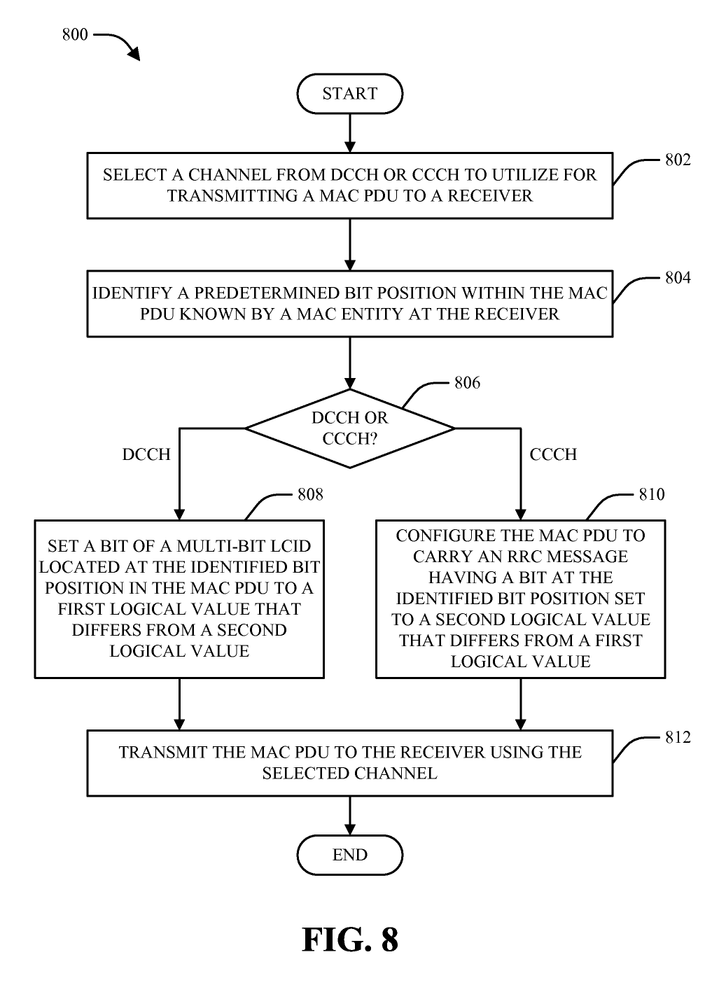

FIG. 8 illustrates a methodology 800 for incorporating a channel identifier into a transmission for a wireless receiver (e.g., a receiving device 230). Methodology 800 can be performed by, for example, a Node B, a UE, and/or any other suitable network device (e.g., acting as a transmitting device 210). Methodology 800 begins at block 802, wherein a channel is selected from between CCCH or DCCH to be utilized for transmitting a MAC PDU (e.g., PDU 220) to a receiver. At block 804, a predetermined bit position within the MAC PDU known by a MAC entity at the receiver (e.g., CCB position 222) is identified.

Next, methodology 800 proceeds to block 806, wherein methodology 800 branches based on whether DCCH or CCCH was selected at block 802. If DCCH was selected, methodology 800 continues to block 808, wherein a bit of a multi-bit LCID located at the bit position of the MAC PDU identified at block 804 is set (e.g., as illustrated by diagram 602) to a first logical value (e.g., 1) that differs from a second logical value. In contrast, if CCCH was selected, methodology 800 instead proceeds to block 810, wherein the MAC PDU is configured to carry an RRC message having a bit at the identified bit location set (e.g., as illustrated by diagram 604) to a second logical value (e.g., 0) that differs from the first logical value used at block 808. Finally, upon completing the acts described at either block 808 or block 810, methodology 800 can conclude at block 812, wherein the MAC PDU is transmitted to the receiver using the channel selected at block 802.

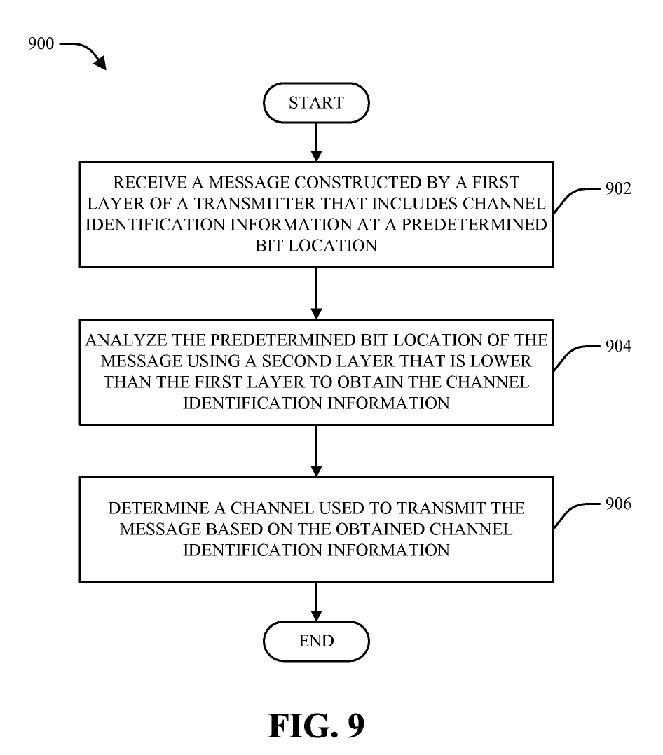

Turning to FIG. 9, illustrated is a methodology 900 for analyzing a message transmitted over a wireless communication system to discover a channel over which the message was transmitted. It is to be appreciated that methodology 900 can be performed by, for example, an access point, a mobile station, and/or any other appropriate network device (e.g., acting as a receiving device 130 and/or 230). Methodology 900 begins at block 902, wherein a message constructed by a first layer (e.g., RRC) of a transmitter that includes channel identification information at a predetermined bit location is identified. Next, at block 904, a second layer (e.g., MAC) that is lower than the first layer is utilized to analyze the predetermined bit location of the message received at block 902 in order to obtain the channel identification information therein. Methodology 900 can then conclude at block 906, wherein a channel used to transmit the message at block 902 is determined based on the channel identification information obtained at block 904.

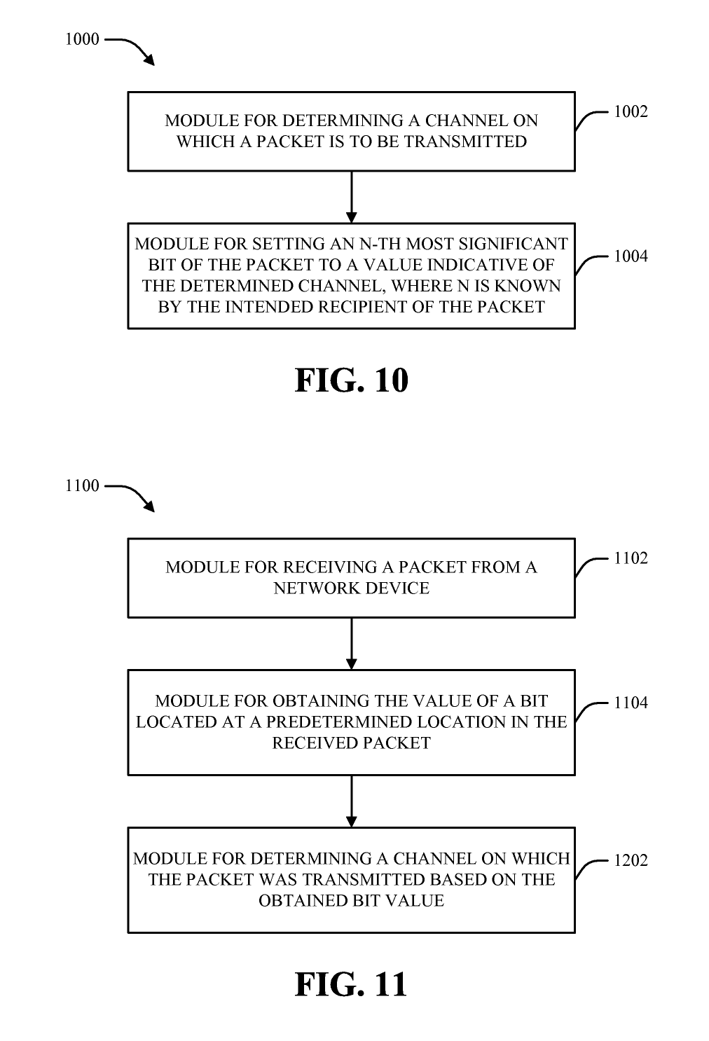

Turning now to FIG. 10, an apparatus 1000 that facilitates channel differentiation in a wireless communication system is illustrated. It is to be appreciated that apparatus 1000 is represented as including functional blocks, which can be functional blocks that represent functions implemented by a processor, software, or combination thereof (e.g., firmware). Apparatus 1000 can be implemented by any suitable wireless communication device with the ability to conduct transmissions to other devices (e.g., base station, mobile terminal, etc.) and can include a module 1002 for determining a channel on which a packet is to be transmitted and a module 1004 for setting an n-th most significant bit of the packet to a value indicative of the determined channel, where n is known by the intended recipient of the packet.

FIG. 11 illustrates an apparatus 1100 that facilitates channel identification in a wireless communication system. It is to be appreciated that apparatus 1100 is represented as including functional blocks, which can be functional blocks that represent functions implemented by a processor, software, or combination thereof (e.g., firmware). Apparatus 1100 can be implemented by any suitable wireless communication device having the ability to receive transmissions from other devices (e.g., Node B, UE, etc.) and can include a module 1102 for receiving a packet from a network device, a module 1104 for obtaining the value of a bit located at a predetermined location in the received packet, and a module 1106 for determining a channel on which the packet was transmitted based on the obtained bit value.

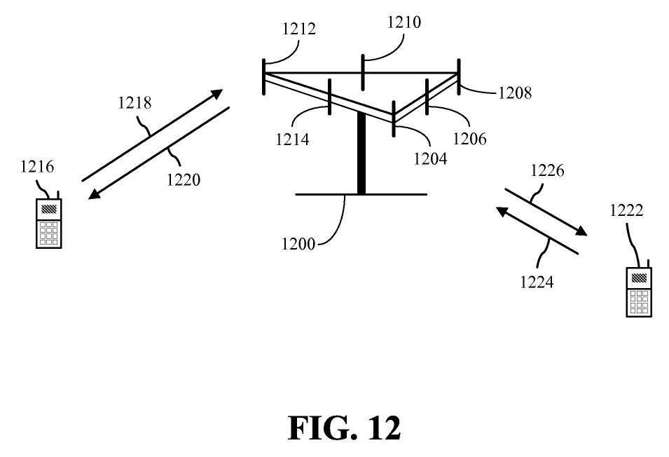

Referring now to FIG. 12, an illustration of a wireless multiple-access communication system is provided in accordance with various aspects. In one example, an access point 1200 (AP) includes multiple antenna groups. As illustrated in FIG. 12, one antenna group can include antennas 1204 and 1206, another can include antennas 1208 and 1210, and another can include antennas 1212 and 1214. While only two antennas are shown in FIG. 12 for each antenna group, it should be appreciated that more or fewer antennas may be utilized for each antenna group. In another example, an access terminal 1216 can be in communication with antennas 1212 and 1214, where antennas 1212 and 1214 transmit information to access terminal 1216 over forward link 1220 and receive information from access terminal 1216 over reverse link 1218. Additionally and/or alternatively, access terminal 1222 can be in communication with antennas 1206 and 1208, where antennas 1206 and 1208 transmit information to access terminal 1222 over forward link 1226 and receive information from access terminal 1222 over reverse link 1224. In a frequency division duplex system, communication links 1218, 1220, 1224 and 1226 can use different frequency for communication. For example, forward link 1220 may use a different frequency then that used by reverse link 1218.

Each group of antennas and/or the area in which they are designed to communicate can be referred to as a sector of the access point. In accordance with one aspect, antenna groups can be designed to communicate to access terminals in a sector of areas covered by access point 1200. In communication over forward links 1220 and 1226, the transmitting antennas of access point 1200 can utilize beamforming in order to improve the signal-to-noise ratio of forward links for the different access terminals 1216 and 1222. Also, an access point using beamforming to transmit to access terminals scattered randomly through its coverage causes less interference to access terminals in neighboring cells than an access point transmitting through a single antenna to all its access terminals.

An access point, e.g., access point 1200, can be a fixed station used for communicating with terminals and can also be referred to as a base station, a Node B, an access network, and/or other suitable terminology. In addition, an access terminal, e.g., an access terminal 1216 or 1222, can also be referred to as a mobile terminal, user equipment, a wireless communication device, a terminal, a wireless terminal, and/or other appropriate terminology.

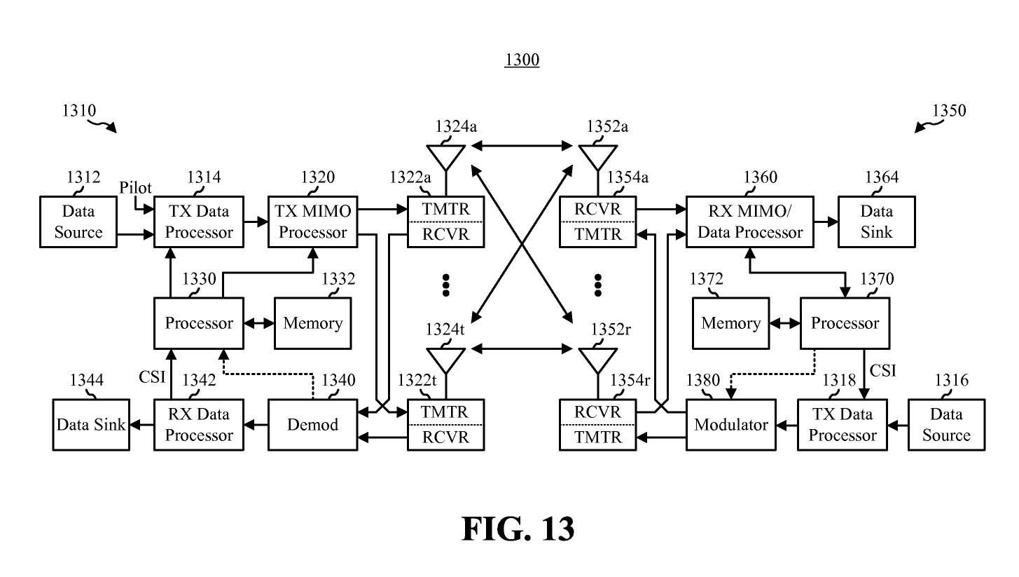

Referring now to FIG. 13, a block diagram illustrating an example wireless communication system 1300 in which various aspects described herein can function is provided. In one example, system 1300 is a multiple-input multiple-output (MIMO) system that includes a transmitter system 1310 and a receiver system 1350. It should be appreciated, however, that transmitter system 1310 and/or receiver system 1350 could also be applied to a multi-input single-output system wherein, for example, multiple transmit antennas (e.g., on a base station), can transmit one or more symbol streams to a single antenna device (e.g., a mobile station). Additionally, it should be appreciated that aspects of transmitter system 1310 and/or receiver system 1350 described herein could be utilized in connection with a single output to single input antenna system.

In accordance with one aspect, traffic data for a number of data streams are provided at transmitter system 1310 from a data source 1312 to a transmit (TX) data processor 1314. In one example, each data stream can then be transmitted via a respective transmit antenna 1324. Additionally, TX data processor 1314 can format, encode, and interleave traffic data for each data stream based on a particular coding scheme selected for each respective data stream in order to provide coded data. In one example, the coded data for each data stream can then be multiplexed with pilot data using OFDM techniques. The pilot data can be, for example, a known data pattern that is processed in a known manner. Further, the pilot data can be used at receiver system 1350 to estimate channel response. Back at transmitter system 1310, the multiplexed pilot and coded data for each data stream can be modulated (i.e., symbol mapped) based on a particular modulation scheme (e.g., BPSK, QSPK, M-PSK, or M-QAM) selected for each respective data stream in order to provide modulation symbols. In one example, data rate, coding, and modulation for each data stream can be determined by instructions performed on and/or provided by processor 1330.

Next, modulation symbols for all data streams can be provided to a TX processor 1320, which can further process the modulation symbols (e.g., for OFDM). TX MIMO processor 1320 can then provides N_{T} modulation symbol streams to N_{T} transceivers 1322a through 1322t. In one example, each transceiver 1322 can receive and process a respective symbol stream to provide one or more analog signals. Each transceiver 1322 can then further condition (e.g., amplify, filter, and upconvert) the analog signals to provide a modulated signal suitable for transmission over a MIMO channel. Accordingly, N_{T} modulated signals from transceivers 1322a through 1322t can then be transmitted from N_{T} antennas 1324a through 1324t, respectively.

In accordance with another aspect, the transmitted modulated signals can be received at receiver system 1350 by N_{R} antennas 1352a through 1352r. The received signal from each antenna 1352 can then be provided to respective transceivers 1354. In one example, each transceiver 1354 can condition (e.g., filter, amplify, and downconvert) a respective received signal, digitize the conditioned signal to provide samples, and then processes the samples to provide a corresponding “received” symbol stream. An RX MIMO/data processor 1360 can then receive and process the N_{R} received symbol streams from N_{R} transceivers 1354 based on a particular receiver processing technique to provide N_{T} “detected” symbol streams. In one example, each detected symbol stream can include symbols that are estimates of the modulation symbols transmitted for the corresponding data stream. RX processor 1360 can then process each symbol stream at least in part by demodulating, deinterleaving, and decoding each detected symbol stream to recover traffic data for a corresponding data stream. Thus, the processing by RX processor 1360 can be complementary to that performed by TX MIMO processor 1320 and TX data processor 1313 at transmitter system 1310. RX processor 1360 can additionally provide processed symbol streams to a data sink 1364.

In accordance with one aspect, the channel response estimate generated by RX processor 1360 can be used to perform space/time processing at the receiver, adjust power levels, change modulation rates or schemes, and/or other appropriate actions. Additionally, RX processor 1360 can further estimate channel characteristics such as, for example, signal-to-noise-and-interference ratios (SNRs) of the detected symbol streams. RX processor 1360 can then provide estimated channel characteristics to a processor 1370. In one example, RX processor 1360 and/or processor 1370 can further derive an estimate of the “operating” SNR for the system. Processor 1370 can then provide channel state information (CSI), which can comprise information regarding the communication link and/or the received data stream. This information can include, for example, the operating SNR. The CSI can then be processed by a TX data processor 1318, modulated by a modulator 1380, conditioned by transceivers 1354a through 1354r, and transmitted back to transmitter system 1310. In addition, a data source 1316 at receiver system 1350 can provide additional data to be processed by TX data processor 1318.

Back at transmitter system 1310, the modulated signals from receiver system 1350 can then be received by antennas 1324, conditioned by transceivers 1322, demodulated by a demodulator 1340, and processed by a RX data processor 1342 to recover the CSI reported by receiver system 1350. In one example, the reported CSI can then be provided to processor 1330 and used to determine data rates as well as coding and modulation schemes to be used for one or more data streams. The determined coding and modulation schemes can then be provided to transceivers 1322 for quantization and/or use in later transmissions to receiver system 1350. Additionally and/or alternatively, the reported CSI can be used by processor 1330 to generate various controls for TX data processor 1314 and TX MIMO processor 1320. In another example, CSI and/or other information processed by RX data processor 1342 can be provided to a data sink 1344.

In one example, processor 1330 at transmitter system 1310 and processor 1370 at receiver system 1350 direct operation at their respective systems. Additionally, memory 1332 at transmitter system 1310 and memory 1372 at receiver system 1350 can provide storage for program codes and data used by processors 1330 and 1370, respectively. Further, at receiver system 1350, various processing techniques can be used to process the N_{R} received signals to detect the N_{T} transmitted symbol streams. These receiver processing techniques can include spatial and space-time receiver processing techniques, which can also be referred to as equalization techniques, and/or “successive nulling/equalization and interference cancellation” receiver processing techniques, which can also be referred to as “successive interference cancellation” or “successive cancellation” receiver processing techniques.

It is to be understood that the aspects described herein can be implemented by hardware, software, firmware, middleware, microcode, or any combination thereof. When the systems and/or methods are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

What has been described above includes examples of one or more aspects. It is, of course, not possible to describe every conceivable combination of components or methodologies for purposes of describing the aforementioned aspects, but one of ordinary skill in the art can recognize that many further combinations and permutations of various aspects are possible. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is meant to be a “non-exclusive or.”

What is claimed is:

1. A method for indicating a channel associated with a transmission in a wireless communication system, comprising:
identifying a channel on which a data packet is to be transmitted from a first channel or a second channel;
formatting the data packet using a protocol associated with a first layer according to a format associated with the identified channel; and
setting a bit in the data packet at a position known by a second layer at an intended recipient of the data packet to a first logical value if the first channel has been identified or to a second logical value if the second channel has been identified.

2. The method of claim 1, wherein the second layer is lower than the first layer.

3. The method of claim 1, wherein the first layer is a Radio Resource Control (RRC) layer and the second layer is a Medium Access Control (MAC) layer.

4. The method of claim 1, wherein the intended recipient of the data packet is a user equipment (UE).

5. The method of claim 1, wherein the intended recipient of the data packet is a Node B.

6. The method of claim 1, wherein the position at which the bit in the data packet is set corresponds to a fourth most significant bit in the data packet.

7. The method of claim 1, wherein the first channel is a Dedicated Control Channel (DCCH) and the second channel is a Common Control Channel (CCCH).

8. The method of claim 7, wherein the first logical value is 1 and the second logical value is 0.

9. The method of claim 7, wherein the first logical value is 0 and the second logical value is 1.

10. The method of claim 7, wherein the setting comprises setting a most significant bit of a Logical Channel Identifier (LCID) to the first logical value if DCCH is identified as the channel on which the data packet is to be transmitted.

11. The method of claim 7, wherein the setting comprises allocating one or more bits immediately preceding the predetermined bit position to a message type field and encoding a message type indication in the message type field by selecting a value from a set comprising a predefined number of message type values if CCCH is identified as the channel on which the data packet is to be transmitted.

12. The method of claim 11, wherein the predefined number of message type values exceeds a number of message types available to the protocol associated with the first layer and at least one of the predefined number of message type values is reserved as a spare value.

13. The method of claim 12, wherein a first element of respective message types available to the protocol associated with the first layer contains a Boolean element set to a constant value.

14. A wireless communications apparatus, comprising:
a memory that stores data relating to a Radio Resource Control (RRC) layer protocol, a first channel, a second channel, and a receiving device; and
a processor configured to select a channel for transmitting a Protocol Data Unit (PDU) to the receiving device from the first channel and the second channel, to format the PDU using the RRC layer protocol based on a PDU structure associated with the selected channel, and to set a bit in the PDU at a predefined position known by a Medium Access Control (MAC) entity at the receiving device to a first logical value if the first channel is selected or a second logical value if the second channel is selected.

15. The wireless communications apparatus of claim 14, wherein the receiving device is one or more of a base station or a terminal.

16. The wireless communications apparatus of claim 14, wherein the predefined position in the PDU corresponds to a fourth most significant bit in the PDU.

17. The wireless communications apparatus of claim 14, wherein the first channel is a Dedicated Control Channel (DCCH) and the second channel is a Common Control Channel (CCCH).

18. The wireless communications apparatus of claim 14, wherein the first logical value and the second logical value are selected from the group consisting of 0 and 1 such that the first logical value is different than the second logical value.

19. The wireless communications apparatus of claim 14, wherein the processor is further configured to set a most significant bit of a Logical Channel Identifier (LCID) to the first logical value if DCCH is identified as the channel to be utilized for transmitting the PDU.

20. The wireless communications apparatus of claim 14, wherein the processor is further configured to allocate one or more bits preceding the predefined position in the PDU for a message type field and to encode a message type indication in the message type field by selecting a value from a set comprising a predefined number of message type values if CCCH is identified as the channel to be utilized for transmitting the PDU.

21. The wireless communications apparatus of claim 20, wherein the predefined number of message type values exceeds a number of message types available to the RRC layer protocol and the processor is further configured to reserve at least one of the message type values as respective buffer values.

22. The wireless communications apparatus of claim 21, wherein the processor is further configured to configure a first element of respective message types available to the RRC layer protocol to contain a Boolean element set to a constant value.

23. An apparatus that facilitates channel differentiation in a wireless communication system, the apparatus comprising:
means for determining a channel on which a packet is to be transmitted; and
means for setting an n-th most significant bit of the packet to a value indicative of the determined channel, where n is known by an intended recipient of the packet.

24. The apparatus of claim 23, wherein n is equal to 4.

25. The apparatus of claim 23, wherein:
the means for determining comprises means for selecting one of a Dedicated Control Channel (DCCH) or a Common Control Channel (CCCH); and
the means for setting comprises means for setting the n-th most significant bit of the packet to a predefined value selected from the group consisting of 0 and 1 upon selecting DCCH or to a logical inverse of the predefined value upon selecting CCCH.

26. A computer program product, comprising:
a computer-readable medium, comprising:
code for determining whether a Medium Access Control (MAC) Protocol Data Unit (PDU) is to be transmitted using a first channel or a second channel; and
code for setting a logical value at a predefined bit position within the MAC PDU that is known a priori to an intended receiver of the MAC PDU to a first logical value if the MAC PDU is to be transmitted using the first channel or to a second logical value if the MAC PDU is to be transmitted using the second channel.

27. The computer program product of claim 26, wherein the first channel is a Common Control Channel (CCCH), the second channel is a Dedicated Control Channel (DCCH), the first logical value is a value selected from the group consisting of 0 and 1, and the second logical value is a value selected from the group consisting of 0 and 1 that is different from the first logical value.

28. An integrated circuit that executes computer-executable instructions for providing channel identification information within a data transmission, the instructions comprising:
selecting a logical channel associated with a data transmission from the group consisting of a first logical channel and a second logical channel;
identifying a bit position within the data transmission that is known to an intended recipient of the data transmission; and
setting the identified bit position to a first value selected from the group consisting of 0 and 1 if the first logical channel has been selected or to a second value selected from the group consisting of 0 and 1 that is different from the first value if the second logical channel has been selected.

29. A method for identifying a channel associated with a packet transmission, comprising:
receiving a packet constructed by a first layer associated with a transmitting device that includes a channel identification bit at a predetermined bit location;
analyzing the predetermined bit location in the packet using a second layer to obtain the channel identification bit; and
determining a channel associated with the packet based on a logical value of the channel identification bit.

30. The method of claim 29, wherein the second layer is lower than the first layer.

31. The method of claim 29, wherein the first layer is a Radio Resource Control (RRC) layer and the second layer is a Medium Access Control (MAC) layer.

32. The method of claim 29, wherein the transmitting device is one or more of a user equipment (UE) or a Node B.

33. The method of claim 29, wherein the predetermined bit location in the packet corresponds to a fourth most significant bit in the packet.

34. The method of claim 29, wherein the determining comprises:
determining whether the channel identification bit has a logical value of 0 or 1; and
associating the packet with a first channel if the channel identification bit has a logical value of 0 or a second channel if the channel identification bit has a logical value of 1.

35. The method of claim 34, wherein the first channel is a Dedicated Control Channel (DCCH) and the second channel is a Common Control Channel (CCCH).

36. The method of claim 34, wherein the first channel is a CCCH and the second channel is a DCCH.

37. The method of claim 29, wherein the analyzing is performed prior to parsing the packet.

38. The method of claim 37, further comprising utilizing a protocol associated with the first layer to parse the packet based on the determined channel.

39. A wireless communications apparatus, comprising:
a memory that stores data relating to a transmitting station, a first channel, a second channel, and an integer n; and
a processor configured to receive a Protocol Data Unit (PDU) from the transmitting station, extract a value of an n-th most significant bit within the PDU, and to associate the first channel with the PDU if the extracted value is a first logical value or to associate the second channel with the PDU if the extracted value is a second logical value.

40. The wireless communications apparatus of claim 39, wherein the transmitting station is one or more of a mobile station or a base station.

41. The wireless communications apparatus of claim 39, wherein the integer n is equal to 4.

42. The wireless communications apparatus of claim 39, wherein the first logical value and the second logical value are selected from the group consisting of 0 and 1 such that the first logical value is different from the second logical value.

43. The wireless communications apparatus of claim 39, wherein the first channel is a Dedicated Control Channel (DCCH) and the second channel is a Common Control Channel (CCCH).

44. The wireless communications apparatus of claim 39, wherein the processor is configured to extract the value of the n-th most significant bit within the PDU prior to parsing the PDU.

45. An apparatus that facilitates identification of a channel associated with a transmitted packet, the apparatus comprising:
means for receiving a packet from a network device;
means for obtaining a value of a bit located at a predetermined location in the packet; and
means for determining a channel on which the packet was transmitted based on the obtained bit value.

46. The apparatus of claim 45, wherein the predetermined location in the packet is a fourth most significant bit in the packet.

47. The apparatus of claim 45, wherein the means for determining comprises means for associating a first channel with the packet if the obtained bit value is 0 or associating a second channel with the packet if the obtained bit value is 1.

48. A computer program product, comprising:
a computer-readable medium, comprising:
code for receiving a Medium Access Control (MAC) Protocol Data Unit (PDU);
code for extracting a logical value associated with a predefined bit position within the MAC PDU; and
code for parsing the MAC PDU according to a first channel format if the extracted logical value is 0 or according to a second channel format if the extracted logical value is 1.

49. The computer program product of claim 48, wherein the first channel format and the second channel format are selected from the group consisting of a Common Control Channel (CCCH) and a Dedicated Control Channel (DCCH) such that the first channel format is different than the second channel format.

50. An integrated circuit that executes computer-executable instructions for identifying a channel over which a data transmission is provided, the instructions comprising:
identifying a bit position within a data transmission that is known to a device from which the data transmission is provided;
obtaining a value selected from the group consisting of 0 and 1 from the identified bit position of the data transmission; and
determining that a first channel was used for the data transmission if the obtained value is 0 or that a second channel was used for the data transmission if the obtained value is 1.
